(19) United States
(12) Patent Application Publication
(10) Pub. No.: US 2023/0415336 A1
(43) Pub. Date: Dec. 28, 2023

(54) ROBOTS FOR AUTONOMOUS DATA CENTER MAINTENANCE

(71) Applicant: NVIDIA Corporation, Santa Clara, CA (US)

(72) Inventors: Siddha Ganju, Santa Clara, CA (US); Elad Mentovich, Tel Aviv (IL); James Stephen Fields, JR., Santa Fe, NM (US); Ryan Kelsey Albright, Beaverton, OR (US); Jonathan Tremblay, Redmond, WA (US); Stanley Thomas Birchfield, Sammamish, WA (US)

(21) Appl. No.: 17/849,861

(22) Filed: Jun. 27, 2022

(51) Int. Cl. B25J 9/16; G05B 19/4155

(52) U.S. Cl. CPC B25J 9/163; G05B 19/4155; G05B 2219/50391; G05B 2219/32226

(57) ABSTRACT

A robot device determines an error associated with equipment included in a data center environment. The robot device may compare the error to candidate errors for which the robot device is already trained to resolve. Based on a result of the comparison, the robot device may perform, in a control environment, candidate maintenance operations in association with resolving the error. The robot device may learn a set of actions associated with successfully resolving the error, based on performing the candidate maintenance operations. The robot device may perform maintenance operations associated with the error. Performing the maintenance operations may include applying the learned set of actions.

### FIELD OF TECHNOLOGY

The present disclosure is generally directed to data center maintenance, in particular, toward robot devices for autonomous data center maintenance.

### BACKGROUND

Data center maintenance may include regular testing, monitoring, and repair of equipment. Improved techniques for data center maintenance are desired.

### SUMMARY

The described techniques relate to methods, systems, devices, and apparatuses that support autonomous data center maintenance.

Examples may include one of the following features, or any combination thereof.

A robot device described herein includes: electronic circuitry; memory in electronic communication with the electronic circuitry; and instructions stored in the memory, the instructions being executable by the electronic circuitry to: determine an error associated with one or more equipment included in a data center environment; and perform one or more maintenance operations associated with the error.

In some examples, the instructions are further executable by the electronic circuitry to: perform, in a control environment, one or more candidate maintenance operations in association with resolving the error; and learn a set of actions associated with successfully resolving the error, based on performing the one or more candidate maintenance operations, wherein performing the one or more maintenance operations includes applying the set of actions.

In some examples, the instructions are further executable by the electronic circuitry to: compare the error to a set of candidate errors for which the robot device is already trained to resolve, wherein performing the one or more candidate maintenance operations in the control environment is based on a result of the comparison.

In some examples, the control environment is a simulation environment corresponding to the data center environment.

In some examples, the instructions are further executable by the electronic circuitry to: process at least one of sensor data and performance data associated with the data center environment, wherein determining the error is based on a result of the processing.

In some examples, the processing includes providing at least one of the sensor data and performance data to a machine learning model; and determining the error includes predicting the error and a set of parameters associated with the error in response to the machine learning model processing at least one of the sensor data and the performance data.

In some examples, wherein the instructions are further executable by the electronic circuitry to: process multimedia data associated with the one or more equipment, the data center environment, or both, wherein the multimedia data includes at least one image data and auditory data, wherein determining the error is based on a result of the processing.

In some examples, the instructions are further executable by the electronic circuitry to: receive data including an error code associated with the one or more equipment, wherein determining the error is based on receiving the data.

In some examples, the instructions are further executable by the electronic circuitry to: output a notification associated with the error; and performing the one or more maintenance operations in response to receiving a user input corresponding to the notification.

In some examples, the notification includes a proposed solution corresponding to the error, the proposed solution including the one or more maintenance operations; and the user input includes confirmation of the proposed solution.

In some examples, the user input includes: an indication of the one or more maintenance operations; and a set of parameters associated with the one or more maintenance operations.

In some examples, the notification includes a request for a physical intervention, by a user, in association with performing the one or more maintenance operations.

In some examples, the instructions are further executable by the electronic circuitry to: identify at least one of a priority level and a risk level associated with the error, wherein outputting the notification is in response to at least one of the priority level and the risk level satisfying one or more criteria.

In some examples, performing the one or more maintenance operations includes at least one of: performing the one or more maintenance operations by the robot device; transmitting one or more control signals to an end effector of the robot device, in association with performing the one or more maintenance operations; and transmitting one or more second control signals to another robot device in association with performing the one or more maintenance operations.

A data center environment described herein includes: one or more equipment; and a robot device including: electronic circuitry; memory in electronic communication with the electronic circuitry; and instructions stored in the memory, the instructions being executable by the electronic circuitry to: determine an error associated with the one or more equipment; and perform one or more maintenance operations associated with the error.

In some examples, the instructions are further executable by the electronic circuitry to: perform, in a control environment, one or more candidate maintenance operations in association with resolving the error; and learn a set of actions associated with successfully resolving the error, based on performing the one or more candidate maintenance operations, wherein performing the one or more maintenance operations includes applying the set of actions.

In some examples, the instructions are further executable by the electronic circuitry to: compare the error to a set of candidate errors for which the robot device is already trained to resolve, wherein performing the one or more candidate maintenance operations in the control environment is based on a result of the comparison.

In some examples, the instructions are further executable by the electronic circuitry to: process, at the robot device or a server in electronic communication with the robot device, at least one of sensor data and performance data associated with the data center environment, wherein determining the error is based on a result of the processing.

A method described herein includes: determining, by a robot device, an error associated with one or more equipment included in a data center environment; and performing, by the robot device, one or more maintenance operations associated with the error.

In some examples, the method includes: performing, in a control environment, one or more candidate maintenance operations in association with resolving the error; and learning a set of actions associated with successfully resolving the error, based on performing the one or more candidate maintenance operations, wherein performing the one or more maintenance operations includes applying the set of actions.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIGS. 1A and 1B illustrate examples of a system that supports autonomous data center maintenance in accordance with aspects of at least one embodiment.

FIG. 2 illustrates an example process flow that supports autonomous data center maintenance in accordance with aspects at least one embodiment.

FIG. 3 illustrates an example of a data flow diagram that supports autonomous data center maintenance in accordance with aspects of at least one embodiment.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Various aspects of the present disclosure will be described herein with reference to drawings that may be schematic illustrations of idealized configurations.

Data center maintenance may include regular testing, monitoring, and repair of equipment. Some data center environments can present safety hazards for a human operator due to factors such as temperature extremes, noise levels, and maneuverability within the environments. For example, when servicing (e.g., repairing, maintaining, diagnosing, etc.) a server, a human operator may need to use a forklift or mechanical left due to the weight of the server. In some cases, such use of a forklift or mechanical lift may require user training and be a safety hazard.

In some cases, environmental conditions associated with a data center environment may be non-ideal for human operators. For example, temperature conditions associated with equipment operation (e.g., high temperatures reached by equipment, cooling of the equipment, etc.) may be excessive for human operators. In some examples, some areas (e.g., “hot” aisles) of the data center environment may be inaccessible to human operators due to temperature extremes associated with the areas. For example, due to safety precautions in some data center environments, human operators may be able to enter “cold” aisles but unable to enter “hot” aisles.

It is with respect to the above issues and other problems that the embodiments presented herein were contemplated.

Aspects described herein support a data center environment in which a system of robot devices (also referred to herein as “robots”) can communicate with each other and, as a team, maintain the data center. In some aspects, a robot device can determine and implement informed decisions while triaging issues in the data center. The robot device may be pretrained to resolve errors and perform maintenance operations associated with equipment included in the data center.

If the robot device identifies an error for which the robot device has not been trained to resolve (e.g., a problem never seen before by robot device), the robot device may attempt to resolve the error in a simulated environment. The robot device may learn, from results of the simulation, a solution (e.g., maintenance operations, component replacement, component repositioning, etc.) for resolving the error. The robot device may implement the solution autonomously.

In some embodiments, the system may support coordination between robot devices for data center maintenance on a management console (e.g., using telecommunication services such as Wi-fi or Bluetooth communications). For example, a robot device may learn a solution (e.g., maintenance operation, component replacement, etc.) for resolving an error associated with equipment. The robot device may implement the solution independently or in combination with another robot device. In an example, the robot device may implement the solution by transmitting control signals to another robot device, and the other robot device may perform a maintenance operation in response to the control signals.

The system may support autonomous and/or semi-autonomous (e.g., human in the loop) implementations by robot devices. For example, if a priority level and/or a risk level associated with the error is below a threshold value, the robot device may implement the solution autonomously (e.g., without user confirmation/approval of the solution). In some alternative and/or additional aspects, the robot device may implement the solution autonomously if a priority level and/or a risk level associated with the equipment is below a threshold value. The robot device may implement (and learn from) the solution as implemented by the robot device.

In another example, if the priority level and/or the risk level associated with the error (and/or the equipment) is above the threshold value, the robot device may implement the solution semi-autonomously (e.g., the robot device may request user confirmation/approval of the solution). In some cases, the robot device may provide details of the error to the user, and the user may provide a solution based on the details. The robot device may implement (and learn from) the solution provided by the user. Accordingly, for example, the system supports a ‘human in the loop component’ in which a robot device may send a push notification to a human operator (e.g., Information Technology (IT) personnel) for operator confirmation of a solution, prior to implementing the solution.

The system may support any combination of robot types. For example, the system may support a combination of robot types, in which different robot devices are capable of (e.g., specialized for) different respective tasks, examples of which are later described herein.

An example robot device of the system may be a mobile robot device capable of traversing the entirety of the data center environment via, for example, wheels, treads, or the like. In some example implementations, the robot device may include one or more end effectors via which the robot device may manipulate (e.g., grasp, move, etc.) objects.

Another example robot device may include a robot device mechanically coupled to a server rack included in the data center environment. For example, the robot device may be mechanically coupled to rails of the server rack. In some aspects, the robot device may be flexible and agile and capable of movements in multiple dimensions (e.g., vertical movements and horizontal movements) with respect to the server rack. In some example implementations, the robot device may be permanently coupled to the server rack or removable from the server rack.

In some embodiments, each robot device may be capable of operating in environments in which temperatures exceed a threshold temperature. For example, each robot device may be capable of operating at temperatures unsafe for human operators. In some examples, each robot device may be rated for operation at temperatures at or above “hot” aisle temperatures (e.g., 50 degrees Celsius, 60 degrees Celsius, etc.) specified by Occupational Safety and Health Authority (OSHA) regulations.

Examples of operations supported by the system and robot devices of the system are described herein. Example operations include component inspection, maintenance, and/or replacement. In some embodiments, example operations include performing AI based health checks, anomaly detection, and/or predictive analysis on device components (e.g., GPUs, switches, server components, etc.) included in a server rack.

Data Center Maintenance Activities

Visual Inspection: The system may review measured information associated with a data center environment. For example, the system may analyze operating parameters, equipment performance (e.g., generator performance), air temperature, water temperature, and humidity as measured by measurement devices (e.g., sensors, measurement instruments, etc.) included in the data center environment. The system may support implementing AI techniques capable of detecting anomalies based on an analysis of the measured information. For example, the system may compare the measured information to historical values or patterns stored in a database, based on which the system may identify anomalies.

In some aspects, the system may output one or more alerts, in which the alerts are triggered in response to detecting the anomalies. In some examples, visual inspection may include capturing and analyzing image data of data center environment or equipment in the data center environment, aspects of which are later described herein.

Cleaning: Using the robot devices, the system may implement operations associated with cleaning the data center environment and equipment therein. Examples of the operations include removing dust accumulation, cleaning server racks and cabinets, changing filters (e.g., air filters), sweeping and/or vacuuming under raised floors, but are not limited thereto. Aspects of the present disclosure support cleaning with increased precision compared to some systems.

Testing: Using the robot devices, the system may test critical components and systems based on a temporal schedule (e.g., regularly) so as to ensure the components and systems are operating within target specifications. In an example, the robot devices may perform UPS battery testing in association with preventing system failure. For example, in some data center environments, UPS battery testing is critical for preventing system failure. In an example implementation, on a regular cycle, a main console (e.g., a central robot device of the system, a central controller, a server, etc.) can instruct a team of robot devices to conduct testing of the critical components and systems. The system may support performing predictive analytics using AI implemented at the main console, one or more robot devices, and/or one or more servers.

Reporting and Monitoring: Using measurements, reports, and other analyses determined by the system or the robot devices, the system may identify trends and changes in the data center infrastructure. Based on the trends and changes, the system may pinpoint existing issues requiring equipment repair or replacement. Aspects of reporting and monitoring described herein may be automated with self-supervised learning (SSL) and active learning techniques.

Repairs: Using the robot devices, the system may perform corrective maintenance in association with equipment in the data center environment. Examples of corrective maintenance supported by the system include repairs (e.g., tightening nuts and bolts) or replacing components (e.g., replacing bearings, motors, etc.). In some data center environments, repair and replacement decisions are a critical part of the maintenance process to ensure reliability of system operations. In an example implementation, the system may modify and adapt robot functionality to suit form factors of equipment included in the data center environment.

For example, the system may support modifying and adapting grasping functions of robot devices to suit current form factor of equipment components (e.g., nuts, bolts, etc.) using imitation learning and reinforcement learning. In some aspects, the robot devices may perform predictive maintenance. For example, the system or a robot device may predict and/or calculate when equipment may fail or require replacement, and the robot device may perform operations associated with repairing or replacing the equipment.

Data Center Planning Software

Inventory Management: The system may record and monitor the physical locations and attributes of all equipment included in the data center environment. Example attributes include physical dimensions, performance capabilities, age, identification information, position relative to surroundings, and model number, but are not limited thereto.

Configuration Management: The system may support efficient planning and management of a data center environment. For example, the system may generate and maintain a complete model of the data center environment.

Capacity Tracking: The system may assess and evaluate infrastructure capacities (e.g., processing ability, ability to handle data traffic and/or data storage, memory usage, etc.) of the data center environment. The system may align resources (e.g., memory, processors, network switches, etc.) to meet data center requirements. In some aspects, the system may predict changes to data center requirements and allocate the resources to meet the updated data center requirements.

Reporting: The system may monitor the status of the data center based on information (e.g., measurement data) provided by measurement devices in the data center environment and information (e.g., image data, audio data, measurement data, etc.) provided by the robot devices. In an example, using the information, the system may gain insight into the data center status and improve decision making with comprehensive analytics.

In some embodiments of the system, the system may support generating instruction sets based on which the robot devices may execute such operations (e.g., data center maintenance, data center planning). In some aspects, implementing such operations using the robot devices may reduce or eliminate reliance on human operators to implement the same operations, which may provide improved precision and reliability. For example, implementing such operations using the robot devices may reduce or eliminate errors associated with decisions made by human operators.

Aspects of the disclosure are described in the context of an environment such as a data center environment. It should be appreciated, however, that embodiments of the present disclosure are not limited to deployment in these types of environments. In some cases, the techniques described herein support autonomous and/or semi-autonomous maintenance of equipment using robot devices, in any type of environment (e.g., a factory environment, a lab environment, etc.). For example, techniques described herein support autonomous and/or semi-autonomous maintenance of equipment using robot devices, in any type of environment. Example environments may include one or more environmental conditions that are non-ideal for human operators (e.g., due to safety, maneuverability within the environment, etc.).

Examples of processes that support autonomous and/or semi-autonomous maintenance of equipment using robot devices are described. Aspects of the disclosure are further illustrated by and described with reference to apparatus diagrams, system diagrams, and flowcharts that relate to autonomous and/or semi-autonomous maintenance of equipment.

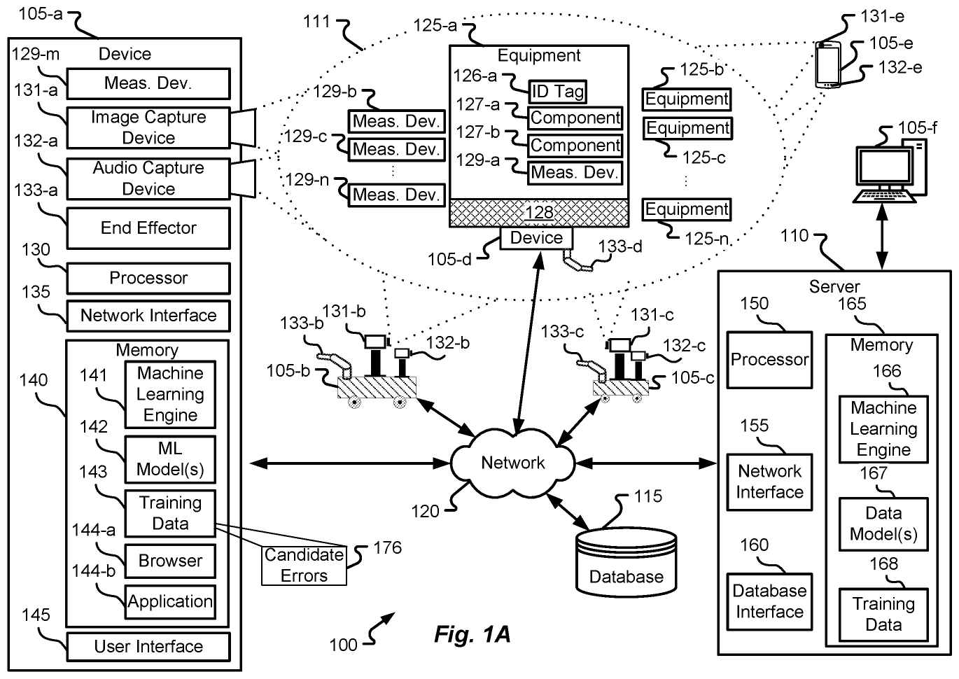

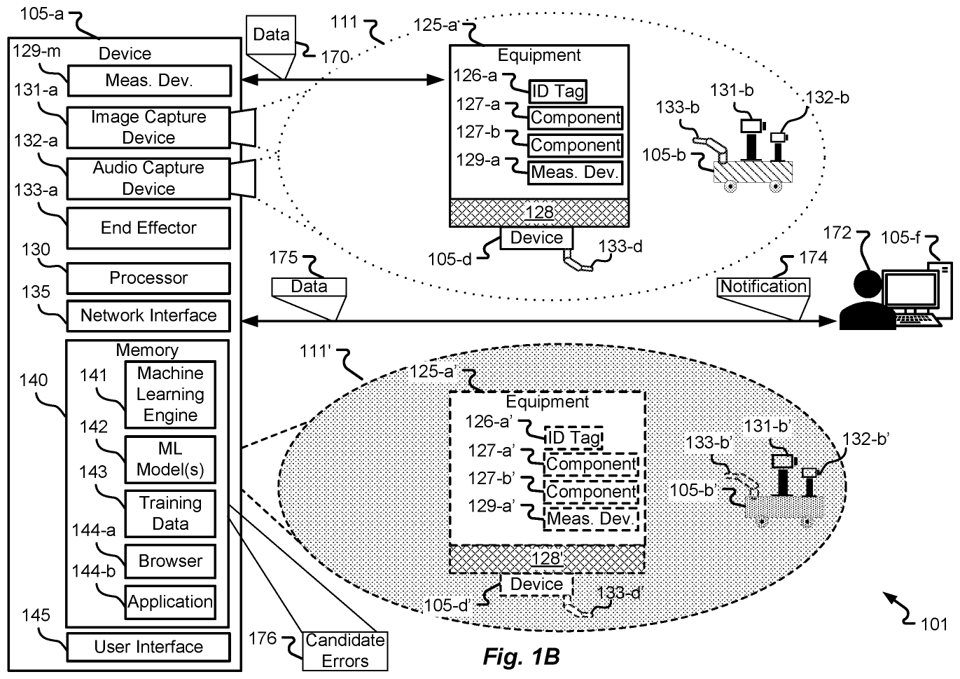

FIG. 1A illustrates an example of a system 100 that supports data center maintenance in accordance with aspects of the present disclosure. In some examples, the system 100 may support autonomous and/or semi-autonomous data center maintenance of an environment 111. The environment 111 may be, for example, a data center environment described herein.

The system 100 may be a control system capable of executing and controlling processes associated with system monitoring, equipment monitoring, and data center infrastructure and maintenance. The system 100 may include a device 105 (or multiple devices 105), a server 110, a database 115, a communication network 120, equipment 125, and measurement devices 129. In some examples, the system 100 may be a control system including controllers (e.g., implemented by a device 105 and/or a server 110). In some aspects, the environment 111 may include a combination of devices 105, servers 110, equipment 125, and measurement devices 129.

The devices 105 may include motorized robot devices (e.g., device 105-a through device 105-d) and communications devices (e.g., device 105-e and device 105-f). For example, device 105-a through device 105-c may be motorized robot devices such as autonomous robot devices, controllable drones, mobile robot devices, or the like. In an example, device 105-a through device 105-c may be capable of movements in multiple dimensions (e.g., vertical movements, horizontal movements, etc.) with respect to the environment 111.

In another example, device 105-d may be a motorized robot device that is electronically and/or mechanically coupled to equipment 125-a via a coupling member 128 of the equipment 125-a. For example, device 105-d may be permanently coupled to or removable from the equipment 125-a. Device 105-d may be capable of movements in multiple dimensions (e.g., vertical movements, horizontal movements, etc.) with respect to the equipment 125-a. In an example, equipment 125-a may be a server rack, and the coupling member 128 may be rails of the server rack.

Movement of the devices 105-a through devices 105-d may be controlled by the system 100 (e.g., via commands by any of the devices 105 or the server 110). In some other aspects, movement of the devices 105-a through device 105-d may be autonomous or semi-autonomous (e.g., based on a schedule, programming, or a trigger condition such as in response to an error code associated with equipment 125).

For example, any of device 105-a through device 105-c may be instructed to patrol and evaluate the environment 111, a target area(s) of the environment 111, and/or target equipment 125 (e.g., any of equipment 125-a through equipment 125-n, where n is an integer value) of the environment 111. In another example, the device 105-d may be instructed to evaluate the equipment 125-a or components 127 of the equipment 125-a, autonomously or semi-autonomously (e.g., based on a schedule, programming, or a trigger condition). Evaluating the environment 111 and/or target equipment 125 may include determining errors in the equipment 125, determining factors (e.g., in the environment 111 or the equipment 125) contributing to the errors, and determining maintenance operations for resolving the errors, aspects of which are later described herein.

Device 105-e and device 105-f may each be a wireless communication device. Non-limiting examples of device 105-e and device 105-f may include, for example, personal computing devices or mobile computing devices (e.g., laptop computers, mobile phones, smart phones, smart devices, wearable devices, tablets, etc.). In some examples, device 105-e and device 105-f may be operable by or carried by a human user.

Any of the devices 105 may include an image capture device 131 (e.g., image sensor) via which the device 105 may capture image data (e.g., static images, video data, etc.) associated with the environment 111 and the equipment 125. In some aspects, any of the devices 105 may include an audio capture device 132 (e.g., audio sensor) via which the device 105 may capture audio data associated with the environment 111 and the equipment 125. In some example embodiments described herein, the devices 105 may evaluate conditions associated with the environment 111 and the equipment 125 based on the image data and/or the audio data. The image data and the audio data may be referred to as multimedia data. Example aspects of the image capture device 131 and the audio capture device 132 are later described herein.

In some other aspects, any of device 105-a through device 105-d (e.g., robot devices) may include an end effector 133 via which the device 105 may interact with and manipulate components 127 of equipment 125. Any of device 105-a through device 105-d may perform one or more operations described herein autonomously or in combination with an input by a user, a control signal by another device 105, and/or a control signal by the server 110.

The server 110 may be, for example, a cloud-based server. In some aspects, the server 110 may be a local server connected to the same network (e.g., LAN, WAN) associated with the devices 105. The database 115 may be, for example, a cloud-based database. In some aspects, the database 115 may be a local database connected to the same network (e.g., LAN, WAN) associated with devices 105, server 110, equipment 125, and measurement devices 129. The database 115 may be supportive of data analytics, machine learning, and AI processing.

The communication network 120 may facilitate machine-to-machine communications between any of the device 105 (or multiple devices 105), the server 110, or one or more databases (e.g., database 115). The communication network 120 may include any type of known communication medium or collection of communication media and may use any type of protocols to transport messages between endpoints. The communication network 120 may include wired communications technologies, wireless communications technologies, or any combination thereof.

The Internet is an example of the communication network 120 that constitutes an Internet Protocol (IP) network consisting of multiple computers, computing networks, and other communication devices located in multiple locations, and components in the communication network 120 (e.g., computers, computing networks, communication devices) may be connected through one or more telephone systems and other means. Other examples of the communication network 120 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 120 may include of any combination of networks or network types. In some aspects, the communication network 120 may include any combination of communication mediums such as coaxial cable, copper cable/wire, fiber-optic cable, or antennas for communicating data (e.g., transmitting/receiving data).

In an example, the environment 111 is a data center environment and the equipment 125 may be a server rack including one or more components 127. Non-limiting examples of the components 127 include technical equipment such as routers, switches, hubs, servers, processors (e.g., GPUs), data cables, power cables, and components thereof.

The equipment 125 may include any type of equipment having a measurable parameter. In some aspects, the measurable parameters may be associated with performance of the equipment 125 and/or a component 127 included therein. For example, the measurable parameters may be associated with resource usage (e.g., power usage, memory usage, processing efficiency, etc.) and/or a condition (e.g., temperature) of the equipment 125. Non-limiting examples of the equipment 125 include a server rack, a filtration device (e.g., an air filtration device), and a UPS battery, but are not limited thereto. For example, the equipment 125 may include any equipment included in a data center, a processing facility, a manufacturing facility, or the like.

The measurement devices 129 may be capable of measuring operating parameters (e.g., equipment performance) associated with the equipment 125. In some aspects, the measurement devices 129 may be capable of measuring operating parameters (e.g., air temperature, water temperature, humidity, noise level, noise frequency, etc.) associated with the environment 111. The measurement devices 129 may include any combination of sensor devices described herein.

In some aspects, a measurement device 129 (e.g., measurement device 129-a) may be integrated with, electrically coupled to, and/or mechanically coupled to equipment 125 (e.g., equipment 125-a). Additionally, or alternatively, a measurement device 129 (e.g., measurement device 129-b) may be physically separate from equipment 125 (e.g., equipment 125-a).

In some examples, the system 100 may be a distributed control system including controllers (e.g., implemented by a device 105 and/or a server 110) capable of controlling devices 105 for extracting measurement information from the measurement devices 129.

The devices 105 may support extracting the measurement information through capturing, processing, and analyzing images of the measurement devices 129 (e.g., capturing images of meters of the measurement devices 129). Additionally, or alternatively, the devices 105 may receive or extract data including the measurement information from the measurement devices 129 via wired or wireless communications, example aspects of which are described herein. In some aspects, the system 100 may support storing, at a database 115, measurement information provided by the measurement devices 129. In some examples, the devices 105 may retrieve the measurement information from the database 115 via wired or wireless communications. Additionally, or alternatively, the devices 105 may include any combination of measurement devices 129 (e.g., measurement device 129-f).

In some embodiments, the devices 105 may evaluate physical conditions (e.g., loose nuts or bolts, worn bearings or motors, etc.) associated with equipment 125 based on image data captured via image capture device 131. For example, the devices 105 may perform visual inspections of the equipment 125 (and, for example, components 127 thereof) based on the image data.

The measurement devices 129 (e.g., measurement device 129-a through measurement device 129-n) may include sensor devices capable of monitoring or measuring the parameters associated with the equipment 125. In some aspects, a measurement device 129 may include a meter (e.g., an analog meter dial, an analog gauge, a digital meter, a digital gauge, a level meter, etc.) corresponding to a parameter value measurable by the measurement device 129. The meter, for example, may be located on a meter face of the measurement device 129. In some other aspects, a measurement device 129 may include multiple meter dials respectively corresponding to parameter values measurable by the measurement device 129. Each measurement device 129 may include any combination of analog and digital indicators that reflect a parameter value measured by the measurement device 129.

In an example, equipment 125 (e.g., equipment 125-a, equipment 125-b, etc.) may each include an identification tag 126 (e.g., identification tag 126-a) (also referred to herein as an “ID tag”). An identification tag 126 may include identification information (e.g., a combination of letters, numbers, and/or symbols), configuration information (e.g., device type, device parameters, device characteristics, device features), and/or manufacturing information (e.g., date of manufacture, date of installation, etc.) associated with corresponding equipment 125. In some aspects, each component 127 may include an identification tag 126.

In some cases, some equipment 125 (or components 127 thereof) in environment 111 may include an identification tag 126, and other equipment 125 (or components 127 thereof) in environment 111 may not include an identification tag 126.

The measurement devices 129 may support network capability for communications with other devices (e.g., device 105, server 110, etc.) using the communications network 120 (e.g., via protocols supported by the communications network 120). For example, the measurement devices 129 may support communicating measurement data to a device 105, the server 110, etc. over the communications network 120. In some examples, the measurement devices 129 may include internet-of-things (IoT) devices (e.g., IOT sensor devices).

Additionally, or alternatively, some measurement devices 129 may not be connected to the communications network 120. For example, in some cases, the measurement devices 129 may not support network capability for communicating over the communications network 120. Aspects of the present disclosure may include visual meter readings of the measurement devices 129 (e.g., of meters included in the measurement devices 129) by a device 105 using, for example, an image capture device 131.

In some cases, the system 100 may support cross-checking (e.g., validation) between measurements provided between different measurement devices 129. For example, the system 100 may support comparing measurement information provided by measurement device 129-m of device 105-a and a measurement device 129 (e.g., any of measurement device 129-a through measurement device 129-n) included in the environment 111.

In various aspects, settings of the any of the devices 105, the server 110, database 115, the communication network 120, the equipment 125, and the measurement devices 129 may be configured and modified by any user and/or administrator of the system 100. Settings may include thresholds or parameters described herein, as well as settings related to how data is managed. Settings may be configured to be personalized for one or more devices 105, users of the devices 105, and/or other groups of entities, and may be referred to herein as profile settings, user settings, or organization settings. In some aspects, rules and settings may be used in addition to, or instead of, parameters or thresholds described herein. In some examples, the rules and/or settings may be personalized by a user, an administrator, a device 105, or the server 110 for any variable, threshold, user (user profile), device 105 (device profile), entity, or groups thereof.

Aspects of the devices 105 and the server 110 are further described herein. A device 105 (e.g., device 105-a) may include a processor 130, an image capture device 131, an audio capture device 132, an end effector 133, a network interface 135, a memory 140, and a user interface 145. In some examples, components of the device 105 (e.g., processor 130, image capture device 131, audio capture device 132, end effector 133, network interface 135, memory 140, user interface 145) may communicate over a system bus (e.g., control busses, address busses, data busses) included in the device 105. In some cases, the device 105 may be referred to as a computing resource or a robot device.

The image capture device 131 may be a standalone camera device or a camera device integrated with the device 105. The image capture device 131 may support capturing static images and/or video. For example, the image capture device 131 may support autonomous capture of images (e.g., static images, video (and video frames thereof), a video stream (and video frames thereof), a video scan, etc.) In some examples, the image capture device 131 may be separate from the device 105 (e.g., the image capture device 131 may be a camera installed at a fixed location).

In some aspects, the image capture device 131 may include a single image sensor or an array of image sensors (not illustrated). The image sensor(s) may include photodiodes sensitive (e.g., capable of detecting) to light of any frequency band(s) or any defined wavelength range (e.g., visible spectrum, ultraviolet spectrum, infrared spectrum, near infrared spectrum, etc.).

The image capture device 131 may be mechanically mounted to or within a housing of the device 105 in a manner that allows rotational degrees of freedom of the image capture device 131 and/or the image sensor. In another example, the image capture device 131 may be mounted to any surface of the device 105 or any object. In some aspects, the image capture device 131 may be a spherical camera device (e.g., for providing a spherical field of view).

The image capture device 131 (and/or image sensor) may include a location sensor configured to record location information associated with the image capture device 131 (and/or image sensor). In an example, the image capture device 131 may be configured to record and output coordinates, positioning information, orientation information, velocity information, or the like. For example, the image capture device 131 may include an accelerometer, a GPS transponder, an RF transceiver, a gyroscopic sensor, or any combination thereof.

The audio capture device 132 may include any combination of audio sensors capable of detecting and receiving audio signals. In an example, the audio capture device 132 may be a microphone. In some cases, the device 105 may configure a filter (e.g., a frequency filter) associated with capturing audio associated with a target frequency.

The end effector 133 may support interaction of the device 105 (e.g., a robot device, device 105-a) with an environment. The end effector 133 may support manipulation (e.g., grasping, movement, lifting, interaction with, etc.) of objects. In some aspects, the end effector 133 may be coupled to a distal end of a robotic arm (not illustrated) of the device 105. In some aspects, the end effector 133 or the robotic arm may include one or more sensors that enable the processor 130 to determine a precise pose in space of the robotic arm (as well as any object or element held by or secured to the robotic arm or the end effector 133).

The system 100 may support image processing techniques and audio processing techniques implemented at any of the device 105, the server 110, the image capture device 131, and the audio capture device 132. Examples of image processing supported by the system 100 may include image reading, image resizing, image conversion, image enhancement, image adjustment, image transformation, or the like. Examples of audio processing include digital and analog audio signal processing.

In some cases, the device 105 may transmit or receive packets to one or more other devices (e.g., another device 105, the server 110, the database 115, equipment 125, a measurement device 129 (if the measurement device 129 supports network communications)) via the communication network 120, using the network interface 135. The network interface 135 may include, for example, any combination of network interface cards (NICs), network ports, associated drivers, or the like. Communications between components (e.g., processor 130, memory 140) of the device 105 and one or more other devices (e.g., another device 105, the database 115, equipment 125, a measurement device 129 (if supportive of network communications)) connected to the communication network 120 may, for example, flow through the network interface 135.

The processor 130 may correspond to one or many computer processing devices. The processor 130 may include electronic circuitry. For example, the processor 130 may include a silicon chip, such as a FPGA, an ASIC, any other type of IC chip, a collection of IC chips, or the like. In some aspects, the processors may include a microprocessor, CPU, a GPU, or plurality of microprocessors configured to execute the instructions sets stored in a corresponding memory (e.g., memory 140 of the device 105). For example, upon executing the instruction sets stored in memory 140, the processor 130 may enable or perform one or more functions of the device 105.

The memory 140 may include one or multiple computer memory devices. The memory 140 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 140, in some examples, may correspond to a computer-readable storage media. In some aspects, the memory 140 may be internal or external to the device 105.

The processor 130 may utilize data stored in the memory 140 as a neural network (also referred to herein as a machine learning network). The neural network may include a machine learning architecture. In some aspects, the neural network may be or include an artificial neural network (ANN). In some other aspects, the neural network may be or include any machine learning network such as, for example, a deep learning network, a convolutional neural network (CNN), or the like. Some elements stored in memory 140 may be described as or referred to as instructions or instruction sets, and some functions of the device 105 may be implemented using machine learning techniques. In some aspects, the neural network may include a region-based CNN (RCNN), fast-RCNN, faster-RCNN, and or mask-RCNN.

The memory 140 may be configured to store instruction sets, neural networks, and other data structures (e.g., depicted herein) in addition to temporarily storing data for the processor 130 to execute various types of routines or functions. For example, the memory 140 may be configured to store program instructions (instruction sets) that are executable by the processor 130 and provide functionality of machine learning engine 141 described herein. The memory 140 may also be configured to store data or information that is useable or capable of being called by the instructions stored in memory 140. One example of data that may be stored in memory 140 for use by components thereof is a machine learning model(s) 142 (e.g., a data model, a neural network model, an object detection model, or other model described herein) and/or training data 143 (also referred to herein as a training data and feedback).

The machine learning engine 141 may include a single or multiple engines. The device 105 (e.g., the machine learning engine 141) may utilize one or more machine learning models 142 for recognizing and processing information obtained from other devices 105, the server 110, and the database 115. In some aspects, the device 105 (e.g., the machine learning engine 141) may update one or more machine learning models 142 based on learned information included in the training data 143. In some aspects, the machine learning engine 141 and the machine learning models 142 may support forward learning based on the training data 143. The machine learning engine 141 may have access to and use one or more machine learning models 142. The machine learning engine 141 may support data center maintenance operations described herein using any combination of machine learning models 142 and/or training data 143.

The machine learning model(s) 142 may be built and updated by the machine learning engine 141 based on the training data 143. The machine learning model(s) 142 may be provided in any number of formats or forms. Non-limiting examples of the machine learning model(s) 142 include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), Decision Trees, Support Vector Machines (SVMs), Bayesian classifiers, and/or other types of machine learning models. Other example aspects of the machine learning model(s) 142, such as generating (e.g., building, training) and applying the machine learning model(s) 142, are described with reference to the figure descriptions herein.

According to some embodiments, the machine learning model(s) 142 may include an object detection model. In some aspects, the machine learning model(s) 142 may be a single object detection model trained to detect equipment 125 (and ID tags 126 and components 127 thereof), measurement devices 129, and other objects included in captured images of the environment 111.

The machine learning model(s) 142 may support image analysis techniques such as two-dimensional (2D) and three-dimensional (3D) object recognition, image classification, image segmentation, motion detection (e.g., single particle tracking), video tracking, 3D pose estimation, or the like.

In some examples, the training data 143 may include aggregated captured image data and auditory data associated with the environment 111, equipment 125, and components 127. In some aspects, the training data 143 may include registered image data and auditory data of the environment 111, equipment 125, and components 127. In some aspects, the training data 143 may include aggregated measurement data, such as aggregated measurement information (e.g., measurement values) associated with the measurement devices 129 with respect to one or more temporal periods. In some other examples, the training data 143 may include parameters and/or configurations of devices 105, equipment 125, components 127, and measurement devices 129.

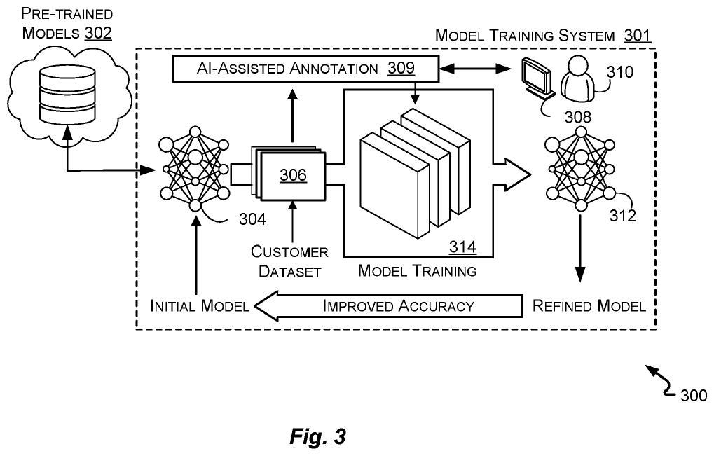

In some aspects, processing associated with training and/or retraining the machine learning model(s) 142 may be implemented on a GPU. Examples of the machine learning model(s) 142, the training data 143, and retraining of the machine learning model(s) 142 are later described herein with reference to FIG. 3.

The machine learning engine 141 may be configured to analyze real-time and/or aggregated measurement information (e.g., measurement values) associated with the measurement devices 129. In some cases, the machine learning engine 141 may support the calculation of predicted performance data associated with equipment 125 and components 127 thereof. For example, the machine learning engine 141 may predict the performance data based on historical data (e.g., previously recorded performance data) associated with the equipment 125 and components 127. In some aspects, the machine learning engine 141 may predict performance trends associated with the equipment 125 and components 127. In some cases, the system 100 may adjust operating parameters associated with the equipment 125 and/or notify an operator of any faults associated with the equipment based on actual measured information and/or predicted measurement information.

In some aspects, the machine learning engine 141 may be configured to analyze and adjust parameters associated with data center maintenance based on the actual measured information and/or predicted measurement information. For example, the machine learning engine 141 may adjust maintenance schedules, equipment 125 to be monitored, etc. based on the actual measured information and/or predicted measurement information.

The machine learning engine 141 may analyze any information described herein that is historical or in real-time. The machine learning engine 141 may be configured to receive or access information from the device 105, the server 110, the database 115, the equipment 125, and/or the measurement devices 129. The machine learning engine 141 may build any number of profiles such as, for example, profiles associated with the system 100 (e.g., profiles associated with the environment 111), profiles associated with equipment 125, etc. using automatic processing, using artificial intelligence and/or using input from one or more users associated with the device 105. The profiles may be, for example, configuration profiles, performance profiles, etc. The machine learning engine 141 may use automatic processing, artificial intelligence, and/or inputs from one or more users of the devices 105 to determine, manage, and/or combine information relevant to a configuration profile.

The machine learning engine 141 may determine configuration profile information based on a user's interactions with information. The machine learning engine 141 may update (e.g., continuously, periodically) configuration profiles based on new information that is relevant. The machine learning engine 141 may receive new information from any device 105, the server 110, the database 115, the equipment 125, the measurement devices 129 (e.g., via image capture, via the communications network 120 if the measurement device 129 supports network communications), or any device via wired or wireless communications described herein. Profile information may be organized and classified in various manners. In some aspects, the organization and classification of configuration profile information may be determined by automatic processing, by artificial intelligence and/or by one or more users of the devices 105.

The machine learning engine 141 may create, select, and execute appropriate processing decisions. Example processing decisions may include analysis of performance data and measurement information (e.g., historical, real-time, etc.), predicted performance data and predicted measurement information, configuration of a device 105, configuration of equipment 125, configuration of a measurement device 129, and/or configuration of the environment 111. Processing decisions may be handled automatically by the machine learning engine 141, with or without human input.

The machine learning engine 141 may store, in the memory 140 (e.g., in a database included in the memory 140), historical information (e.g., reference data, measurement data, predicted measurement data, configurations, etc.). Data within the database of the memory 140 may be updated, revised, edited, or deleted by the machine learning engine 141. In some aspects, the machine learning engine 141 may support continuous, periodic, and/or batch fetching of data (e.g., from devices 105, equipment 125, measurement devices 129, a central controller, etc.) and data aggregation.

The device 105 may render a presentation (e.g., visually, audibly, using haptic feedback, etc.) of an application 144 (e.g., a browser application 144-a, an application 144-b). The application 144-b may be an application associated with data center maintenance described herein. For example, the application 144-b may enable control of any device 105, equipment 125, measurement device 129, other devices (not illustrated) in the environment 111, or component thereof described herein. In some aspects, the application 144-b may be a data center maintenance application associated with testing, monitoring, and repair of equipment 125 included in the environment 111.

In an example, the device 105 may render the presentation via the user interface 145. The user interface 145 may include, for example, a display (e.g., a touchscreen display), an audio output device (e.g., a speaker, a headphone connector), or any combination thereof. In some aspects, the applications 144 may be stored on the memory 140. In some cases, the applications 144 may include cloud-based applications or server-based applications (e.g., supported and/or hosted by the database 115 or the server 110). Settings of the user interface 145 may be partially or entirely customizable and may be managed by one or more users, by automatic processing, and/or by artificial intelligence.

In an example, any of the applications 144 (e.g., browser application 144-a, application 144-b) may be configured to receive data in an electronic format and present content of data via the user interface 145. For example, the applications 144 may receive data from another device 105, the server 110, the database 115, equipment 125, and/or measurement devices 129 (if supportive of network communications) via the communications network 120, and the device 105 may display the content via the user interface 145.

The database 115 may include a relational database, a centralized database, a distributed database, an operational database, a hierarchical database, a network database, an object-oriented database, a graph database, a NoSQL (non-relational) database, etc. In some aspects, the database 115 may store and provide access to, for example, any of the stored data described herein.

The server 110 may include a processor 150, a network interface 155, database interface instructions 160, and a memory 165. In some examples, components of the server 110 (e.g., processor 150, network interface 155, database interface 160, memory 165) may communicate over a system bus (e.g., control busses, address busses, data busses) included in the server 110. The processor 150, network interface 155, and memory 165 of the server 110 may include examples of aspects of the processor 130, network interface 135, and memory 140 of the device 105 described herein.

For example, the processor 150 may be configured to execute instruction sets stored in memory 165, upon which the processor 150 may enable or perform one or more functions of the server 110. In some examples, the server 110 may transmit or receive packets to one or more other devices (e.g., a device 105, the database 115, another server 110) via the communication network 120, using the network interface 155. Communications between components (e.g., processor 150, memory 165) of the server 110 and one or more other devices (e.g., a device 105, the database 115, equipment 125, a measurement device 129, etc.) connected to the communication network 120 may, for example, flow through the network interface 155.

In some examples, the database interface instructions 160 (also referred to herein as database interface 160), when executed by the processor 150, may enable the server 110 to send data to and receive data from the database 115. For example, the database interface instructions 160, when executed by the processor 150, may enable the server 110 to generate database queries, provide one or more interfaces for system administrators to define database queries, transmit database queries to one or more databases (e.g., database 115), receive responses to database queries, access data associated with the database queries, and format responses received from the databases for processing by other components of the server 110.

The memory 165 may be configured to store instruction sets, neural networks, and other data structures (e.g., depicted herein) in addition to temporarily storing data for the processor 150 to execute various types of routines or functions. For example, the memory 165 may be configured to store program instructions (instruction sets) that are executable by the processor 150 and provide functionality of a machine learning engine 166. One example of data that may be stored in memory 165 for use by components thereof is a machine learning model(s) 167 (e.g., any machine learning model described herein, an object detection model, a neural network model, etc.) and/or training data 168.

The machine learning model(s) 167 and the training data 168 may include examples of aspects of the machine learning model(s) 142 and the training data 143 described with reference to the device 105. The machine learning engine 166 may include examples of aspects of the machine learning engine 141 described with reference to the device 105. For example, the server 110 (e.g., the machine learning engine 166) may utilize one or more machine learning models 167 for recognizing and processing information obtained from devices 105, another server 110, the database 115, the equipment 125, image capture devices 131, and/or audio capture devices 132. In some aspects, the server 110 (e.g., the machine learning engine 166) may update one or more machine learning models 167 based on learned information included in the training data 168.

In some aspects, components of the machine learning engine 166 may be provided in a separate machine learning engine in communication with the server 110.

Aspects of the subject matter described herein may be implemented to realize one or more advantages. The described techniques may support example improvements in data center operations. For example, implementing robot devices (e.g., device 105-a through device 105-d) in association with maintaining the data center, rather than sending a human operator into the data center, may support data center configurations in which operating temperatures at the data center may be relatively higher for “hot” aisles and relatively lower for “cold” aisles in comparison to some other data center environments, which may thereby provide power savings in association with operating a data center.

In some cases, aspects of the subject matter described herein may implement robot devices capable of operating under temperature conditions ranging from 15 degrees Celsius to 35 degrees Celsius, but are not limited thereto. In some other cases, the robot devices described herein may be implemented for operation in a data center environment 111 that is entirely immersion cooled (e.g., fully immersed in a cooling fluid) and/or has relatively low (e.g., compared to a threshold) oxygen levels. In some example implementations, the robot devices described herein may be implemented for operation in a data center environment 111 located in a location inaccessible to human operators (e.g., a remote data center inaccessible due to distance, a data center physically inaccessible to a human operator, etc.). Accordingly, for example, the robot devices described herein may operate in environments that are unfriendly for human operators due to operating temperature conditions (e.g., operating temperatures higher or lower than temperatures physically tolerable by human operators) and/or other environmental conditions (e.g., oxygen levels).

FIG. 1B illustrates an example 101 of the system 100. Example implementations in association with some embodiments are described herein with reference to FIGS. 1A and 1B.

The device 105-a (a robot device) may determine an error associated with equipment 125-a included in the data center environment 111. The error may be, for example, performance (e.g., processing efficiency) of a component 127 below a threshold value, an operational parameter (e.g., temperature) exceeding a threshold value, or the like.

In some aspects, the device 105-a may evaluate the equipment 125-a and/or the environment 111 in response to a trigger condition. For example, the device 105-a may evaluate the equipment 125-a and/or environment 111 in response to receiving data 170 from the equipment 125-a. The data 170 may include an error code associated with the equipment 125-a.

The device 105-a may process sensor data associated with the environment 111. The sensor data may include image data (captured by image capture device 131-a) of the equipment 125-a and the environment 111. In some aspects, the sensor data may include auditory data (captured by audio capture device 132-a) associated with the equipment 125-a and the environment 111. In some examples, the auditory data may include any combination of sounds (e.g., beeps, alarms, machine humming, etc.), based on which the device 105-a may evaluate the equipment 125-a for problems to be addressed.

The device 105-a may process performance data associated with the equipment 125-a and/or operational data associated with the environment 111. The performance data associated with the equipment 125-a may include, for example, processing efficiency, power usage, memory usage, temperature, or the like, and is not limited thereto. The operational data may include values of operating parameters (e.g., air temperature, water temperature, humidity, noise level, noise frequency, etc.) associated with the environment 111.

In some cases, the device 105-a may retrieve the performance data and operational data from measurement devices 129 (e.g., measurement device 129-a through measurement device 129-n) of the environment 111 and/or measurement devices 129 (e.g., measurement device 129-m) integrated with the equipment 125-a. In some additional and/or alternative aspects, the device 105-a may determine the performance data and/or operational data using one or more sensor devices (e.g., image capture device 131-a, audio capture device 132-a) or measurement devices (not illustrated) integrated with the device 105-a.

The device 105-a may determine one or more errors associated with the equipment 125-a in response to processing the sensor data, performance data, and operational data described herein. In some aspects, the device 105-a may provide the sensor data, performance data, and/or operational data to machine learning model 142. In response to processing the sensor data, performance data, and/or operational data, the machine learning model 142 may generate an output including an indication of an error predicted by the machine learning model 142. In some aspects, the output may include an indication of a set of parameters associated with the error.

The device 105-a may determine whether the device 105 is already trained to resolve the error. For example, the device 105-a may compare the error to candidate errors 176 for which the device 105-a is already trained to resolve.

In an example, based on the comparison, the device 105-a may identify that the device 105-a is already trained to resolve the error (e.g., the error is included in the candidate errors 176). The device 105-a may identify and/or select, from the training data 143, a maintenance operation that is indicated in the training data 143 as having succeeded in resolving the error. The device 105-a may perform the maintenance operation and evaluate the equipment 125 to verify that the error is resolved.

In an alternative example, based on the comparison, the device 105-a may identify that the device 105-a is not already trained to resolve the error (e.g., the error is not included in the candidate errors 176). The device 105-a may perform, in a control environment 111′, one or more candidate maintenance operations in association with resolving the error. Non-limiting examples of candidate maintenance operations include: replacing a component 127-a (e.g., a GPU), replacing a component 127-b (e.g., a filter), repositioning or relocating a component 127-c (not illustrated) (e.g., cables), performing a cleaning, modifying an operating parameter of a component 127, or the like, and are not limited thereto.

In an example implementation, the control environment 111′ is a simulation environment corresponding to the environment 111. The control environment 111′ may include simulated representations (also referred to herein as virtual representations or virtual models) of any entities included in the environment 111. For example, the control environment 111′ may include equipment 125-a′, a device 105-b′, and a device 105-d′ respectively corresponding to equipment 125-a, device 105-b, and device 105-d. Components of the equipment 125-a′, a device 105-b′, and a device 105-d′ may respectively correspond to components of equipment 125-a, device 105-b, and device 105-d.

In performing candidate maintenance operations in the control environment 111′, the device 105-a may test an action (or combination of actions) in association with resolving the error. For example, in the control environment 111′, the device 105-a may simulate maintenance operations such as repairing a component 127-a′. In another example, the device 105-a may simulate maintenance operations such as replacing a component 127-b′. In some examples, the device 105-a may simulate implementing the maintenance operations using device 105-b′ and/or device 105-d′ (e.g., robot devices).

Based on the results, the device 105-a may identify or “learn” maintenance operations that are successful at resolving the error in the control environment 111′. The maintenance operations may each include an action (or multiple actions) associated with successfully resolving the error. Additionally, or alternatively, the device 105-a may identify or “learn” maintenance operations which would be unsuccessful at resolving the error.

The device 105-a may perform the “learned” maintenance operation in the environment 111 and evaluate the equipment 125 to verify that the error is resolved. In some aspects, the device 105-a may store, to the training data 143, results (i.e., real-life result) associated with applying the “learned” maintenance operation to the environment 111.

For example, if the device 105-a determines that performing the “learned” maintenance operation resolves the error when applied to the environment 111, the device 105-a may indicate in the training data 143-a that the maintenance operation was successful. In some cases, resolving the error may include achieving a target performance result. Alternatively, if the device 105-a determines that performing the “learned” maintenance operation does not resolve the error when applied to the environment 111, the device 105-a may indicate in the training data 143-a that the maintenance operation was unsuccessful. Accordingly, for example, the device 105-a may store, in the training data 143, the error, the “learned” maintenance operations, and a result (i.e., real-life result) of whether the maintenance operations was successful at resolving the error.

The device 105-a may perform the “learned” maintenance operation (or operations) autonomously or semi-autonomously based on one or more criteria. For example, the device 105-a may perform the “learned” maintenance operation autonomously if a priority associated with the error is less than a corresponding priority threshold and/or a risk level associated with the error is less than a corresponding risk level threshold. Additionally, or alternatively, the device 105-a may perform the “learned” maintenance operation autonomously if a priority associated with the equipment 125-a is less than a corresponding priority threshold and/or a risk level associated with the equipment 125-a is less than a corresponding risk level threshold.

In some aspects, the device 105-a may perform the “learned” maintenance operation semi-autonomously if the priority associated with the error is greater than or equal to the corresponding priority threshold and/or the risk level associated with the error is greater than or equal to the corresponding risk level threshold. In some aspects, the device 105-a may perform the “learned” maintenance operation semi-autonomously if the priority associated with the equipment 125-a is greater than or equal to the corresponding priority threshold and/or the risk level associated with the equipment 125-a is greater than or equal to the corresponding risk level threshold.

In some aspects, performing the “learned” maintenance operation semi-autonomously may include outputting a notification 174 associated with the error. For example, the device 105-a may transmit the notification 174 to device 105-f (e.g., a communication device) of a user 172. The notification 174 may include any combination of visual, audible, and haptic alerts. The notification 174 may be data inclusive of any combination of information described herein.

The notification 174 may include a proposed solution corresponding to the error. In an example, the proposed solution may include the “learned” maintenance operation. Additionally, or alternatively, the proposed solution may include a maintenance operation identified by the device 105-a from the training data 143.

In some aspects, the notification 174 may include a combination of proposed solutions. In some cases, the notification 174 may include rankings (e.g., determined by the device 105-a, for example, by the machine learning engine 141) corresponding to the proposed solutions. For example, the notification 174 may include multiple “learned” maintenance operations and/or maintenance operations identified from the training data 143. In some aspects, the notification 174 may include rankings associated with the proposed solutions (and associated maintenance operations) in association with one or more criteria. The criteria may include, for example, probability of success, estimated effectiveness (e.g., performance improvement), or the like.

The device 105-a may perform a maintenance operation(s) associated with a proposed solution in response to receiving a user input corresponding to the notification 174. In an example in which the notification 174 includes a single proposed solution, the user input from the user 172 may include confirmation of the proposed solution and the maintenance operation(s). In an alternative example in which the notification 174 includes a set of proposed solutions (e.g., multiple solutions), the user input may include a user selection of a proposed solution included in the set. In some cases, the user input may include a priority order in which to attempt two or more solutions.

In another example implementation, the device 105-a may refrain from providing a proposed solution. For example, the notification 174 may include an indication of the error and a request for a proposed solution from the user. In some cases, the notification 174 may include an indication of a cause (e.g., as determined by the device 105-a) associated with the error.

Accordingly, for example, the user input may include an indication of a user proposed solution (e.g., user proposed maintenance operation and a set of parameters associated with the maintenance operation). The device 105-f may transmit data 175 indicating the maintenance operation (and parameters associated with therewith) to the device 105-a. In response to receiving the data 175, the device 105-a may perform the maintenance operation and evaluate the equipment 125-a to determine whether the error is resolved. The device 105-a may store, to the training data 143, results associated with applying the maintenance operation to the environment 111, thereby “learning” from the proposed solution from the user.

In some example aspects, the user input may include a high-level instruction in association with applying a maintenance operation. For example, the user input may include a high-level instruction corresponding to a skill(s) performable by one or more devices 105 in the environment 111. In an example, the device 105-a may execute the skill(s) in response to receiving the high-level instruction. For example, the device 105-a may iteratively select tasks associated with the skills and append the selected tasks to the instruction. In some aspects, the device 105-a may utilize a language model (not illustrated) implemented at the memory 140 in association with selecting and appending the tasks to the instruction.

For example, a user may provide a high level-instruction such as “How would you resolve the error at the equipment 125-a?” In some aspects, the user may provide the instruction via the user interface 145. The user may provide the instruction, for example, as a text input via a keyboard (not illustrated) integrated with or electronically coupled to the device 105-f, a voice command via a microphone (not illustrated) integrated with or electronically coupled to the device 105-f, or the like. The instruction may be, for example, a command or control that provides a type of vector based on which the robot device may learn. The language model may respond with an explicit sequence. In a non-limiting example, the language model may generate an output sequence including:
1. Find the equipment 125-a
2. Identify an error associated with a component 127
3. Perform candidate maintenance operation(s) in the control environment 111′ including repairing or replacing the component 127
4. Identify a learned action associated with successfully resolving the error.
5A. If a priority or risk level is below a threshold, automatically perform the learned action.
5B. If the priority or risk level is above the threshold, provide notification to user indicating a proposed solution that includes the learned action. Wait for user input confirming the proposed solution.
6. Done.

In some cases, given a high-level instruction, the device 105-a may combine first probabilities from the language model with second probabilities from a value function to identify and select a learned action to perform. The first probabilities may include probabilities that a skill performable by the device 105-a (independently, or in combination with another robot device) is applicable to the instruction. The skill may be a learned action described herein. The second probabilities may include probabilities that the skill (e.g., learned action) may successfully satisfy the instruction. For example, the second probabilities may include probabilities that the skill may successfully resolve an error associated with the equipment 125-a.

Accordingly, for example, in combining the first and second probabilities, the device 105-a may identify a skill that is both applicable to the instruction and has a relatively high probability of success. In some aspects, the device 105-a may iteratively identify and append skills to the instruction as described herein until the error is successfully resolved.

The device 105-a may perform maintenance operations independently. For example, the device 105-a may transmit control signals to the end effector 133-a of the device 105-a, in association with performing maintenance operations.

Additionally, or alternatively, the device 105-a may perform maintenance operations in combination with other robot devices. For example, the device 105-a may transmit control signals to a robot device (e.g., device 105-b) in association with performing maintenance operations. In some cases, the device 105-a and the device 105-b may each perform a portion of the maintenance operations. In some other aspects, the device 105-a may transmit control signals to the device 105-b, and the device 105-b (based on the control signals) may perform all of the maintenance operations.

Additionally, or alternatively, the device 105-a may perform maintenance operations in combination with physical assistance from the user 172. For example, the notification 174 may include a request for a physical intervention, by the user 172, in association with performing a maintenance operation. In some aspects, the device 105-a may provide the notification 174 to the device 105-f of the user 172 for cases in which the end effector 133-a is unable to manipulate an object (e.g., equipment 125-a, a component 127, etc.) in association with performing the maintenance operation. For example, in some cases, the end effector 133-a may be unable to effectively grasp the object due to capabilities of the end effector 133-a or a size of the object.

The system 100 may support distributed processing in association with determining errors, “learning” maintenance operations for resolving the errors, and performing the maintenance operations described herein. That is, for example, the device 105-a may remotely or directly launch commands and/or diagnostics on a problematic system.

For example, aspects described herein may be implemented at the device 105-a, in combination with other devices 105 (e.g., device 105-b, device 105-f) and the server 110. For example, in association with determining errors associated with equipment 125 described herein, the system 100 may support processing, at the device 105-a, another device 105 (e.g., device 105-b, device 105-f), and/or the server 110, the sensor data and performance data associated with the environment 111. The system 100 may determine errors associated with the equipment 125 based on a result of the processing.

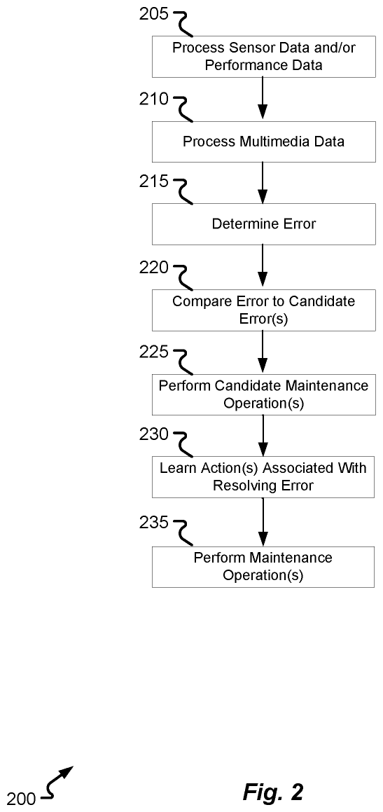

FIG. 2 illustrates an example of a process flow 200 that supports data center maintenance in accordance with aspects of the present disclosure. In some examples, process flow 200 may implement aspects of a device 105 (e.g., a robot device described herein) and/or a server 110 described with reference to FIGS. 1A and 1B.

In the following description of the process flow 200, the operations may be performed in a different order than the order shown, or the operations may be performed in different orders or at different times. Certain operations may also be left out of the process flow 200, or other operations may be added to the process flow 200.

It is to be understood that while a device 105 is described as performing a number of the operations of process flow 200, any device (e.g., another device 105 in communication with the device 105) may perform the operations shown.

At 205, the process flow 200 may include processing at least one of sensor data and performance data associated with a data center environment.

At 210, the process flow 200 may include processing multimedia data associated with one or more equipment included in the data center environment, multimedia data associated with the data center environment, or both. In some aspects, the multimedia data includes at least one image data and auditory data.

At 215, the process flow 200 may include determining an error associated with the one or more equipment included in a data center environment. In some aspects, determining the error is based on a result of the processing at 205. In some aspects, determining the error is based on a result of the processing at 210.

In some aspects (not illustrated), the processing at 205 includes providing at least one of the sensor data and performance data to a machine learning model. In some aspects (not illustrated), the processing at 210 includes providing the multimedia data to a machine learning model. In some aspects, determining the error at 215 includes predicting the error and a set of parameters associated with the error in response to the machine learning model processing at least one of the sensor data and the performance data. In some aspects, determining the error at 215 includes predicting the error and a set of parameters associated with the error in response to the machine learning model processing the multimedia data.

In some aspects (not illustrated), determining the error at 215 is based on (e.g., is in response to) receiving data including an error code associated with the one or more equipment,

In some aspects (not illustrated), the process flow 200 may include processing, at the device or a server in electronic communication with the device, at least one of sensor data and performance data associated with the data center environment. In an example, determining the error at 215 is based on a result of the processing.

At 220, the process flow 200 may include comparing the error to a set of candidate errors for which the device is already trained to resolve.

At 225, the process flow 200 may include performing, in a control environment, one or more candidate maintenance operations in association with resolving the error. In some aspects, performing the one or more candidate maintenance operations in the control environment may be based on a result of the comparison at 220. In some aspects, the control environment is a simulation environment corresponding to the data center environment.

At 230, the process flow 200 may include learning a set of actions associated with successfully resolving the error, based on performing the one or more candidate maintenance operations.

At 235, the process flow 200 may include performing one or more maintenance operations associated with the error.

In some aspects, performing the one or more maintenance operations at 235 includes applying the set of actions learned at 230.

In some aspects, performing the one or more maintenance operations at 235 includes at least one of: performing the one or more maintenance operations by the robot device; transmitting one or more control signals to an end effector of the robot device, in association with performing the one or more maintenance operations; and transmitting one or more second control signals to another robot device in association with performing the one or more maintenance operations.

In some aspects, performing the one or more maintenance operations at 235 may be in response to receiving a user input corresponding to the notification. In some aspects, the user input includes confirmation of a proposed solution. In some aspects, the user input includes: an indication of the one or more maintenance operations; and a set of parameters associated with the one or more maintenance operations.

In some aspects (not illustrated), the process flow 200 may include identifying at least one of a priority level and a risk level associated with the error.

In some aspects (not illustrated), the process flow 200 may include outputting a notification associated with the error. In some aspects, outputting the notification is in response to at least one of the priority level and the risk level satisfying one or more criteria. In some aspects, the notification includes a proposed solution corresponding to the error, the proposed solution including the one or more maintenance operations. In some aspects, the notification includes a request for a physical intervention, by the user, in association with performing the one or more maintenance operations.

FIG. 3 illustrates a data flow diagram for a process 300 to train, retrain, or update a machine learning model, in accordance with at least one embodiment. In at least one embodiment, process 300 may be executed using, as a non-limiting example, system 100 of FIG. 1. In at least one embodiment, process 300 may leverage processors 130 and memory 140 of one or more device 105, as described herein. In at least one embodiment, refined models 312 generated by process 300 may be executed by the system 100 in association with data center maintenance described herein.

In at least one embodiment, model training 301 may include retraining or updating an initial model 304 (e.g., a pre-trained model) using new training data (e.g., new input data, such as a dataset 306 associated with environment 111 of FIG. 1, and/or new ground truth data associated with input data). In at least one embodiment, to retrain, or update, initial model 304, output or loss layer(s) of initial model 304 may be reset, or deleted, and/or replaced with an updated or new output or loss layer(s). In at least one embodiment, initial model 304 may have previously fine-tuned parameters (e.g., weights and/or biases) that remain from prior training, so training or retraining 301 may not take as long or require as much processing as training a model from scratch. In at least one embodiment, during model training 301, by having reset or replaced output or loss layer(s) of initial model 304, parameters may be updated and re-tuned for a new data set based on loss calculations associated with accuracy of output or loss layer(s) at generating predictions on new, customer dataset 306 (e.g., image data captured by an image capture device 131, auditory data captured by an audio capture device 132, measurement information provided by a measurement device 129, etc.).

In at least one embodiment, pre-trained models 302 may be stored in a data store, or registry (e.g., database 115 of FIG. 1, memory 140 of FIG. 1). In at least one embodiment, pre-trained models 302 may have been trained, at least in part, at one or more facilities (e.g., data centers) other than a facility executing process 300. In at least one embodiment, to protect privacy and rights of clients of different facilities, pre-trained models 302 may have been trained, on-premise, using data generated on-premise. In at least one embodiment, pre-trained models 302 may be trained using a cloud network and/or other hardware (e.g., processors, GPUs, etc.), but confidential, privacy protected data may not be transferred to, used by, or accessible to any components of the cloud (or other off premise hardware). In at least one embodiment, where a pre-trained model 302 is trained at using data from more than one facility, pre-trained model 302 may have been individually trained for each facility prior to being trained on data from another facility. In at least one embodiment, such as where data has been released of privacy concerns (e.g., by waiver, for experimental use, etc.), or where data is included in a public data set, data from any number of facilities may be used to train pre-trained model 302 on-premise and/or off premise, such as in a data center or other cloud computing infrastructure.

In at least one embodiment, when selecting applications for use in automated data center maintenance, a user may also select machine learning models to be used for specific applications (e.g., applications 144 of FIG. 1). In at least one embodiment, a user may not have a model for use, so a user may select a pre-trained model 302 to use with an application. In at least one embodiment, pre-trained model 302 may not be optimized for generating accurate results on a dataset 306 of a facility (e.g., based on different equipment 125 or equipment types). In at least one embodiment, prior to deploying pre-trained model 302 for use with an application(s), pre-trained model 302 may be updated, retrained, and/or fine-tuned for use at a respective facility.

In at least one embodiment, a user may select pre-trained model 302 that is to be updated, retrained, and/or fine-tuned, and pre-trained model 302 may be referred to as initial model 304. In at least one embodiment, dataset 306 (e.g., data generated by devices 105 and equipment 125 in an environment 111) may be used to perform model training 301 (which may include, without limitation, transfer learning) on initial model 304 to generate refined model 312. In at least one embodiment, ground truth data corresponding to customer dataset 306 may be generated by a training system (not illustrated). In at least one embodiment, ground truth data may be generated, at least in part, by data center personnel (e.g., data center technicians, IT personnel, etc.).

In at least one embodiment, AI-assisted annotation 309 may be used in some examples to generate ground truth data. In at least one embodiment, AI-assisted annotation 309 (e.g., implemented using an AI-assisted annotation SDK) may leverage machine learning models (e.g., neural networks) to generate suggested or predicted ground truth data for a customer dataset. In at least one embodiment, user 310 may use annotation tools within a user interface (a graphical user interface (GUI)) on computing device 308.

In at least one embodiment, user 310 may interact with a GUI via computing device 308 to edit or fine-tune annotations or auto-annotations.

In at least one embodiment, once customer dataset 306 has associated ground truth data, ground truth data (e.g., from AI-assisted annotation, manual labeling, etc.) may be used by during model training 301 to generate refined model 312. In at least one embodiment, customer dataset 306 may be applied to initial model 304 any number of times, and ground truth data may be used to update parameters of initial model 304 until an acceptable level of accuracy is attained for refined model 312. In at least one embodiment, once refined model 312 is generated, refined model 312 may be deployed within at a facility for performing one or more processing tasks with respect to data center maintenance.

In at least one embodiment, refined model 312 may be uploaded to pre-trained models 302 in the model registry. In at least one embodiment, this process may be completed at any number of data center environments such that refined model 312 may be further refined on new datasets any number of times (and at any number of data center environments) to generate a more universal model.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed embodiments, configuration, and aspects.

The exemplary apparatuses, systems, and methods of this disclosure have been described in relation to a robot device (e.g., device 105). However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

It will be appreciated from the descriptions herein, and for reasons of computational efficiency, that the components of devices and systems described herein can be arranged at any appropriate location within a distributed network of components without impacting the operation of the device and/or system.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Exemplary aspects are directed to a robot device including: electronic circuitry; memory in electronic communication with the electronic circuitry; and instructions stored in the memory, the instructions being executable by the electronic circuitry to: determine an error associated with one or more equipment included in a data center environment; and perform one or more maintenance operations associated with the error.

Any of the aspects herein, wherein the instructions are further executable by the electronic circuitry to: perform, in a control environment, one or more candidate maintenance operations in association with resolving the error; and learn a set of actions associated with successfully resolving the error, based on performing the one or more candidate maintenance operations, wherein performing the one or more maintenance operations includes applying the set of actions.

Any of the aspects herein, wherein the instructions are further executable by the electronic circuitry to: compare the error to a set of candidate errors for which the robot device is already trained to resolve, wherein performing the one or more candidate maintenance operations in the control environment is based on a result of the comparison.

Any of the aspects herein, wherein the control environment is a simulation environment corresponding to the data center environment.

Any of the aspects herein, wherein the instructions are further executable by the electronic circuitry to: process at least one of sensor data and performance data associated with the data center environment, wherein determining the error is based on a result of the processing.

Any of the aspects herein, wherein the processing includes providing at least one of the sensor data and performance data to a machine learning model; and determining the error includes predicting the error and a set of parameters associated with the error in response to the machine learning model processing at least one of the sensor data and the performance data.

Any of the aspects herein, wherein the instructions are further executable by the electronic circuitry to: process multimedia data associated with the one or more equipment, the data center environment, or both, wherein the multimedia data includes at least one image data and auditory data, wherein determining the error is based on a result of the processing.

Any of the aspects herein, wherein the instructions are further executable by the electronic circuitry to: receive data including an error code associated with the one or more equipment, wherein determining the error is based on receiving the data.

Any of the aspects herein, wherein the instructions are further executable by the electronic circuitry to: output a notification associated with the error; and performing the one or more maintenance operations in response to receiving a user input corresponding to the notification.

Any of the aspects herein, wherein the notification includes a proposed solution corresponding to the error, the proposed solution including the one or more maintenance operations; and the user input includes confirmation of the proposed solution.

Any of the aspects herein, wherein the user input includes: an indication of the one or more maintenance operations; and a set of parameters associated with the one or more maintenance operations.

Any of the aspects herein, wherein the notification includes a request for a physical intervention, by a user, in association with performing the one or more maintenance operations.

Any of the aspects herein, wherein the instructions are further executable by the electronic circuitry to: identify at least one of a priority level and a risk level associated with the error, wherein outputting the notification is in response to at least one of the priority level and the risk level satisfying one or more criteria.

Any of the aspects herein, wherein performing the one or more maintenance operations includes at least one of: performing the one or more maintenance operations by the robot device; transmitting one or more control signals to an end effector of the robot device, in association with performing the one or more maintenance operations; and transmitting one or more second control signals to another robot device in association with performing the one or more maintenance operations.

Exemplary aspects are directed to a data center environment including: one or more equipment; and a robot device including: electronic circuitry; memory in electronic communication with the electronic circuitry; and instructions stored in the memory, the instructions being executable by the electronic circuitry to: determine an error associated with the one or more equipment; and perform one or more maintenance operations associated with the error.

Any of the aspects herein, wherein the instructions are further executable by the electronic circuitry to: perform, in a control environment, one or more candidate maintenance operations in association with resolving the error; and learn a set of actions associated with successfully resolving the error, based on performing the one or more candidate maintenance operations, wherein performing the one or more maintenance operations includes applying the set of actions.

Any of the aspects herein, wherein the instructions are further executable by the electronic circuitry to: compare the error to a set of candidate errors for which the robot device is already trained to resolve, wherein performing the one or more candidate maintenance operations in the control environment is based on a result of the comparison.

Any of the aspects herein, wherein the instructions are further executable by the electronic circuitry to: process, at the robot device or a server in electronic communication with the robot device, at least one of sensor data and performance data associated with the data center environment, wherein determining the error is based on a result of the processing.

Exemplary aspects are directed to a method including: determining, by a robot device, an error associated with one or more equipment included in a data center environment; and performing, by the robot device, one or more maintenance operations associated with the error.

Any of the aspects herein, wherein the method includes: performing, in a control environment, one or more candidate maintenance operations in association with resolving the error; and learning a set of actions associated with successfully resolving the error, based on performing the one or more candidate maintenance operations, wherein performing the one or more maintenance operations includes applying the set of actions.

Any one or more of the above aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

In at least one example, architecture and/or functionality of various previous figures are implemented in context of a general computer system, a circuit board system, a game console system dedicated for entertainment purposes, an application-specific system, and more. In at least one example, computer system 700 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

Other variations are within spirit of present disclosure. Thus, while disclosed techniques are susceptible to various modifications and alternative constructions, certain illustrated examples thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed examples (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one example, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain examples require at least one of A, at least one of B and at least one of C each to be present. In addition, unless otherwise noted or contradicted by context, term “plurality” indicates a state of being plural (e.g., “a plurality of items” indicates multiple items). In at least one example, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one example, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one example, code is stored on a computer-readable storage medium, for example, in form of a computer program comprising a plurality of instructions executable by one or more processors. In at least one example, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one example, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one example, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one example, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one example, different components of a computer system have separate processors and different processors execute different subsets of instructions.

Accordingly, in at least one example, computer systems are configured to implement one or more services that singly or collectively perform operations of processes described herein and such computer systems are configured with applicable hardware and/or software that enable performance of operations. Further, a computer system that implements at least one example of present disclosure is a single device and, in another example, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate examples of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one example, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one example, process of obtaining, acquiring, receiving, or inputting analog and digital data can be accomplished in a variety of ways such as by receiving data as a parameter of a function call or a call to an application programming interface. In at least one example, processes of obtaining, acquiring, receiving, or inputting analog or digital data can be accomplished by transferring data via a serial or parallel interface. In at least one example, processes of obtaining, acquiring, receiving, or inputting analog or digital data can be accomplished by transferring data via a computer network from providing entity to acquiring entity. In at least one example, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation, or technique.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

What is claimed is:

1. A robot device, the robot device comprising:
electronic circuitry;
memory in electronic communication with the electronic circuitry; and
instructions stored in the memory, the instructions being executable by the electronic circuitry to:
determine an error associated with one or more equipment included in a data center environment; and
perform one or more maintenance operations associated with the error.

2. The robot device of claim 1, wherein the instructions are further executable by the electronic circuitry to:
perform, in a control environment, one or more candidate maintenance operations in association with resolving the error; and
learn a set of actions associated with successfully resolving the error, based on performing the one or more candidate maintenance operations,
wherein performing the one or more maintenance operations comprises applying the set of actions.

3. The robot device of claim 2, wherein the instructions are further executable by the electronic circuitry to:
compare the error to a set of candidate errors for which the robot device is already trained to resolve,
wherein performing the one or more candidate maintenance operations in the control environment is based on a result of the comparison.

4. The robot device of claim 2, wherein the control environment is a simulation environment corresponding to the data center environment.

5. The robot device of claim 1, wherein the instructions are further executable by the electronic circuitry to:
process at least one of sensor data and performance data associated with the data center environment,
wherein determining the error is based on a result of the processing.

6. The robot device of claim 5, wherein:
the processing comprises providing at least one of the sensor data and performance data to a machine learning model; and
determining the error comprises predicting the error and a set of parameters associated with the error in response to the machine learning model processing at least one of the sensor data and the performance data.

7. The robot device of claim 1, wherein the instructions are further executable by the electronic circuitry to:
process multimedia data associated with the one or more equipment, the data center environment, or both, wherein the multimedia data comprises at least one image data and auditory data,
wherein determining the error is based on a result of the processing.

8. The robot device of claim 1, wherein the instructions are further executable by the electronic circuitry to:
receive data including an error code associated with the one or more equipment,
wherein determining the error is based on receiving the data.

9. The robot device of claim 1, wherein the instructions are further executable by the electronic circuitry to:
output a notification associated with the error; and
performing the one or more maintenance operations in response to receiving a user input corresponding to the notification.

10. The robot device of claim 10, wherein:
the notification comprises a proposed solution corresponding to the error, the proposed solution comprising the one or more maintenance operations; and
the user input comprises confirmation of the proposed solution.

11. The robot device of claim 10, wherein the user input comprises:
an indication of the one or more maintenance operations; and
a set of parameters associated with the one or more maintenance operations.

12. The robot device of claim 10, wherein:
the notification comprises a request for a physical intervention, by a user, in association with performing the one or more maintenance operations.

13. The robot device of claim 10, wherein the instructions are further executable by the electronic circuitry to:
identify at least one of a priority level and a risk level associated with the error,
wherein outputting the notification is in response to at least one of the priority level and the risk level satisfying one or more criteria.

14. The robot device of claim 1, wherein performing the one or more maintenance operations comprises at least one of:
performing the one or more maintenance operations by the robot device;
transmitting one or more control signals to an end effector of the robot device, in association with performing the one or more maintenance operations; and
transmitting one or more second control signals to another robot device in association with performing the one or more maintenance operations.

15. A data center environment comprising:
one or more equipment; and
a robot device comprising:
electronic circuitry;
memory in electronic communication with the electronic circuitry; and
instructions stored in the memory, the instructions being executable by the electronic circuitry to:
determine an error associated with the one or more equipment; and
perform one or more maintenance operations associated with the error.

16. The data center environment of claim 15, wherein the instructions are further executable by the electronic circuitry to:
perform, in a control environment, one or more candidate maintenance operations in association with resolving the error; and
learn a set of actions associated with successfully resolving the error, based on performing the one or more candidate maintenance operations,
wherein performing the one or more maintenance operations comprises applying the set of actions.

17. The data center environment of claim 16, wherein the instructions are further executable by the electronic circuitry to:
compare the error to a set of candidate errors for which the robot device is already trained to resolve,
wherein performing the one or more candidate maintenance operations in the control environment is based on a result of the comparison.

18. The data center environment of claim 16, wherein the instructions are further executable by the electronic circuitry to:
process, at the robot device or a server in electronic communication with the robot device, at least one of sensor data and performance data associated with the data center environment,
wherein determining the error is based on a result of the processing.

19. A method comprising:
determining, by a robot device, an error associated with one or more equipment included in a data center environment; and
performing, by the robot device, one or more maintenance operations associated with the error.

20. The method of claim 19, further comprising:
performing, in a control environment, one or more candidate maintenance operations in association with resolving the error; and
learning a set of actions associated with successfully resolving the error, based on performing the one or more candidate maintenance operations,
wherein performing the one or more maintenance operations comprises applying the set of actions.
